(19) United States
(12) Patent Application Publication
(10) Pub. No.: US 2023/0191875 A1
(43) Pub. Date: Jun. 22, 2023

(54) MOTOR VEHICLE AIR-CONDITIONING SYSTEM AND METHOD FOR OPERATING THE SAME

(71) Applicant: Hanon Systems, Daejeon (KR)

(72) Inventor: Detlef Handwerk, Köln (DE)

(21) Appl. No.: 18/051,918

(22) Filed: Nov. 2, 2022

(30) Foreign Application Priority Data
Dec. 17, 2021 (DE) 10 2021 133 658.9

(51) Int. Cl. B60H 1/00

(52) U.S. Cl. CPC B60H 1/00864; B60H 1/00521; B60H 2001/00635

(57) ABSTRACT

A motor vehicle air-conditioning system includes a housing for guiding an air flow, wherein air outlets for the air supply into the motor vehicle interior are formed. An evaporator through-flowable by the air flow, and a thermal heat exchanger arranged in the housing downstream of the evaporator. A cold air path bypassing the thermal heat exchanger and a warm air path running through the thermal heat exchanger lead downstream into a mixing space connected to the air outlets. At least one separating wall runs through the housing and separates the housing into at least two flow areas along the cold air path, the warm air path, the mixing space and the air outlets. Air outlet areas can be closed and opened by means of operating flaps, and an air bypass can be closed and opened for a direct fluidic connection between at least two temperature zones.

### CROSS-REFERENCE TO RELATED PATENT APPLICATIONS

This patent application claims priority to German Patent Application No. DE 10 2021 133 658.9 filed on Dec. 17, 2021, the entire disclosure of which is hereby incorporated herein by reference.

### FIELD

The invention relates to a motor vehicle air-conditioning system and a method for operating such motor vehicle air-conditioning system.

### BACKGROUND

Modern motor vehicles are designed to save energy for interior air-conditioning. This is usually realized by throttling or switching off the air supply for the non-used seats. Therefore, closing the corresponding operating flaps of the air-conditioning system is the common solution.

Common heat exchangers built into the motor vehicle air-conditioning system, such as evaporators, coolant heaters or condensers, are single-zone devices and lose power and efficiency during heat transfer when the air flow is partially blocked by a zone circuit. A second aspect is the inefficient use of the internal cross-section of air-conditioning systems for guiding air with partial deactivation of air supply.

### SUMMARY

The object the invention is based on is to maintain the use of heat exchangers and flow cross-sections for guiding air within the air-conditioning system during the phases of temporary partial deactivation of individual air supplies into the vehicle, for example for non-occupied seats in the vehicle.

The object of the invention is achieved by a motor vehicle air-conditioning system with the features as disclosed herein.

A motor vehicle air-conditioning system according to the invention comprises:
a housing for guiding an air flow, in which air outlets for the air supply into the motor vehicle interior are formed,
an evaporator through-flowable by the air flow, and a thermal heat exchanger arranged in the housing, through-flowable by the air flow downstream of the evaporator, wherein, starting from the evaporator, a cold air path bypassing the thermal heat exchanger and a warm air path running through the thermal heat exchanger lead downstream into a mixing space, which is connected to the air outlets,
at least one separating wall which runs through the housing such that it separates the housing into at least two flow areas for the air flow along the cold air path, the warm air path, the mixing space and the air outlets, which represent two temperature zones that can be air-conditioned and are spatially separated from one another, which have air outlet areas for the air supply into respective different areas of a motor vehicle interior, wherein the air outlet areas can be closed and opened by means of operating flaps, and
an air bypass which can be closed and opened, for a direct fluidic connection between the at least two temperature zones.

The concept of the invention is to add an air bypass within the zone separation of the air-conditioning system, for example an air bypass from the passenger side to the driver side. This enables the use of the complete active thermal heat exchanger surface for the air-conditioning of the remaining temperature zones in case other temperature zones are deactivated through the deactivation function of the air supply into the motor vehicle interior. By using the air bypass, the thermal efficiency of the air-conditioning system is increased and the air pressure drop is decreased as the internal cross-section of the air supply of the motor vehicle air-conditioning system is used more efficiently than in the case of a deactivation function of the air supply without an air bypass. Along with this, a lower level of noise which is caused by the flow of the air, a lower energy demand at the air fan and a more efficient operation of the heat exchangers, both of the thermal heat exchanger and the evaporator, are to be expected.

In an embodiment of the invention, the air bypass is designed in the shape of a through opening within the separating wall which can be closed and opened and leads from one temperature zone to the other temperature zone.

Advantageously, the air bypass is in the region of the mixing space in which the cold air path and the warm air path meet.

According to a preferred embodiment of the invention, a bypass flap, with which the air bypass can be closed and opened, is arranged on the air bypass. For this, the motor vehicle air-conditioning system can have a flap adjustment drive with which the bypass flap can be adjusted between a closed position and at least one opened position. Such a flap adjustment drive generally comprises a drive engine and a drive axis. The bypass flap preferably has a sealing running around its edge in order to seal the air bypass in the closed position of the bypass flap.

According to a particularly advantageous embodiment of the invention, there is an operative connection between an activation and deactivation function of the air supply from a temperature zone into the motor vehicle interior and an activation and deactivation function of the air bypass in that the air bypass is closed or opened in dependence on the activation or deactivation of the air supply from this temperature zone. Preferably, the operative connection is between at least one operating flap of the temperature zone by means of which the temperature zone can be activated by opening the air outlet areas for air supply into the motor vehicle interior or deactivated by closing the same, and the bypass flap of the air bypass by means of which the air bypass can be opened or closed.

A preferred embodiment of the invention is that of the at least two temperature zones, a first temperature zone is located on the driver side of the motor vehicle air-conditioning system as a driver zone and is connected to air outlets which can be closed and opened for air supply for the driver seat, and the second temperature zone, separated from the first temperature zone by the separating wall, is located on the passenger side of the motor vehicle air-conditioning system as a passenger zone and is connected to air outlet areas which can be closed and opened for air supply for the passenger seat.

A further aspect of the invention relates to a method for operating the motor vehicle air-conditioning system according to the invention in any of the embodiments described above, in which the air bypass is closed or opened depending on the activation or deactivation of the air supply from at least one of the temperature zones. Preferably, when the air supply from a temperature zone into the motor vehicle interior is deactivated, a partial air flow flowing in this temperature zone is redirected into an adjacent temperature zone by the opened air bypass, the air supply of which into the motor vehicle interior is activated, and, together with the partial air flow of the adjacent temperature zone exits into the motor vehicle interior via its air outlet areas.

### DESCRIPTION OF DRAWINGS

Further details, features and advantages of embodiments of the invention result from the following description of example embodiments with reference to the accompanying drawings.

The following is shown:

FIG. 1: a structure of the motor vehicle air-conditioning system according to the state of the art with a closed separating wall between two temperature zones,

FIG. 2: a motor vehicle air-conditioning system as an example embodiment for the present invention in the setting without partial deactivation of individual air supplies,

FIG. 3: the same motor vehicle air-conditioning system in a setting with partial deactivation of individual air supplies,

FIG. 4: a sectional side view of the motor vehicle air-conditioning system with the required components, and

FIG. 5: a side view of the separating wall and a detailed view of a bypass flap with a drive engine and a drive axis.

### DETAILED DESCRIPTION OF EMBODIMENTS

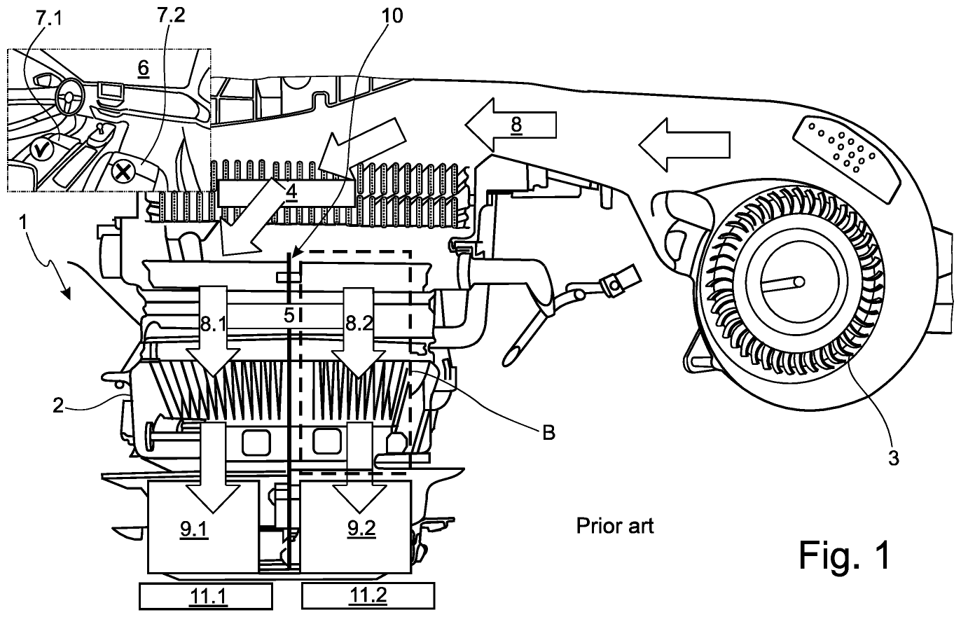

FIG. 1 contains a schematic view of a motor vehicle air-conditioning system 1 according to the state of the art as a plan view. Such a motor vehicle air-conditioning system 1 comprises a housing 2 and a fan 3 arranged therein, an evaporator 4 and a thermal heat exchanger 5. The fan 3 serves to transport air through the motor vehicle air-conditioning system 1 into the motor vehicle interior, wherein in the upper left part of FIG. 1, a partial area of the motor vehicle interior 6 with a driver seat 7.1 and a passenger seat 7.2 is represented in perspective. The air flow 8 thus created is outlined in the shape of arrows in the plan view of the motor vehicle air-conditioning system 1. The housing 2 provides an internal cross-section of the air-conditioning system for guiding an air flow 8. The air flow 8 first passes the evaporator 4 and is thus cooled. Subsequently, the air flow 8 is guided into a mixing space via a warm air path through the thermal heat exchanger 5 positioned downstream of the evaporator or via a cold air path without going through the thermal heat exchanger 5. From the mixing space, the air flow 8 goes into the motor vehicle interior 6 via air outlets. In FIG. 1, the motor vehicle air-conditioning system 1 is represented as an example in the form of an air-conditioning system with two temperature zones in which a driver zone 9.1 for the area of the driver seat 7.1 and a passenger zone 9.2 in the area of the passenger seat 7.2 are air-conditioned. For temperature zone separation, the motor vehicle air-conditioning system 1 has a separating wall 10 which serves to separate the air flow 8 into a partial air flow 8.1 guided within the driver zone 9.1 and a partial air flow 8.2 guided in the passenger zone 9.2 and to separate both partial air flows 8.1, 8.2 from one another. When the driver zone 9.1 is activated, there is an air supply from the air guided in the partial air flow 8.1 into the motor vehicle interior 6 via corresponding air outlets on the side of the driver seat 7.1, the driver side 11.1. Correspondingly, there is an air supply from the air guided in the partial air flow 8.2 in the passenger zone 9.2 into the motor vehicle interior 6 via air outlets on the side of the passenger seat 7.2, the passenger side 11.2, when the passenger zone 9.2 is activated. When the passenger zone 9.2 is deactivated, there is no air supply via the air outlets on the passenger side 11.2 from the air guided in the partial air flow 8.2 in the passenger zone 9.2 into the motor vehicle interior 6 and thus no air supply for the passenger seat 7.2.

In the representation of FIG. 1, the motor vehicle air-conditioning system 1 is in an operating condition in which only one of the two temperature zones 9.1, 9.2, the driver zone 9.1, is activated and therefore the air supply into the motor vehicle interior 6 is via the air outlets on the driver side 11.1 for the driver seat 7.1 only. In contrast, the passenger zone 9.2 and therefore also the air supply via the air outlets of the passenger side 11.2 for the passenger seat 7.2 are deactivated. This is the case, for example, when the driver seat 7.1 is occupied, indicated in the upper left part of the representation by a circle with a check-mark, the passenger seat 7.2, on the other hand, remains empty, indicated in the upper left part of the representation by a crossed-out circle. This setting of the motor vehicle air-conditioning system 1 is also referred to as an operating mode for the driver side. The deactivation of the air supply for the passenger seat 7.2 leads to the prevention of the complete partial air flow 8.2 within the passenger zone 9.2, which is to the right of the separating wall 10 in the representation of FIG. 1. The shown evaporator 4 and the thermal heat exchanger 5 are, in contrast to the motor vehicle air-conditioning-system 1 into which they are built, which is an air-conditioning system with two zones, typical devices with one zone and lose performance and efficiency during heat transfer when the air flow 8 is partially blocked through the deactivation of the air flow for a seat. Moreover, there is an inefficient use of the internal cross-section of the air-conditioning system for guiding air in case of partial air deactivation, as also schematically demonstrated in FIG. 1. According to this representation, about 50% of the cross-section and of the heat exchanger surface of the evaporator 4 or of the heat exchanger surface of the thermal heat exchanger 5 are blocked, represented as area B. This means that for example the part of the thermal heat exchanger 5 which is to be associated with the passenger zone 9.2 cannot be used for a heat transfer from the thermal heat exchanger 5 to the air flow 8 determined for the motor vehicle interior 6 due to the blocked partial air flow 8.2 within the passenger zone 9.2.

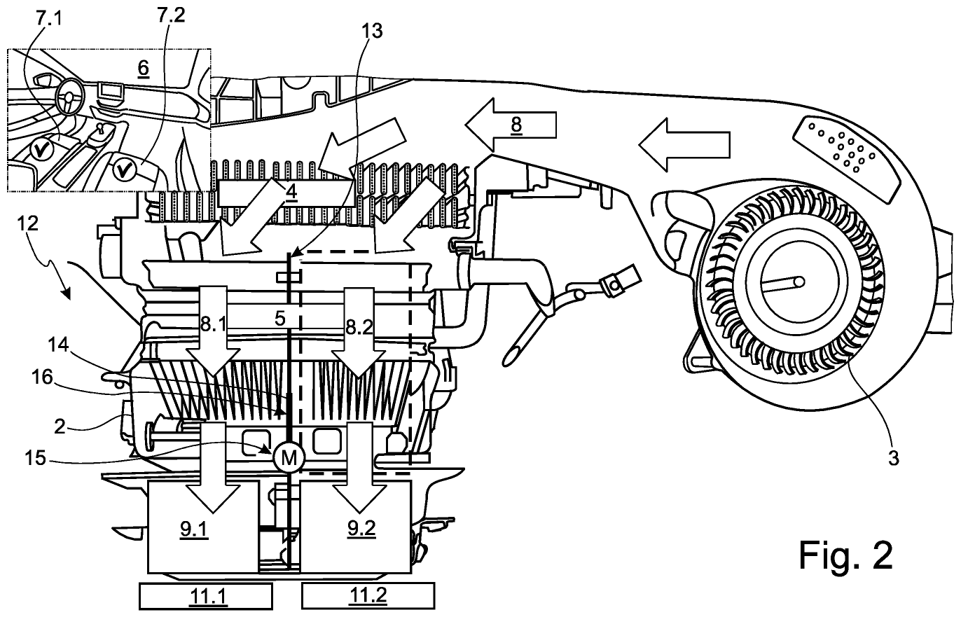

FIG. 2 schematically represents a motor vehicle air-conditioning system 12 according to the invention with the example of an air-conditioning system with two zones. This motor vehicle air-conditioning system 12 also comprises a housing 2 and a fan 3 arranged therein, an evaporator 4 and a thermal heat exchanger 5. The fan 3 serves to transport air through the motor vehicle air-conditioning system 12 into the motor vehicle interior 6, wherein in the upper left part of FIG. 2, a partial area of the motor vehicle interior 6 with a driver seat 7.1 and a passenger seat 7.2 is represented in perspective. The air flow 8 thus created is outlined in the shape of arrows in FIG. 2. The air flow 8 first passes the evaporator 4 and is thus cooled. Subsequently, the air flow 8 is guided into a mixing space via a warm air path through the thermal heat exchanger 5 positioned downstream of the evaporator or via a cold air path without going through the thermal heat exchanger 5 and past it. From the mixing space, the air flow goes into the motor vehicle interior 6 via air outlets. In FIG. 1, the motor vehicle air-conditioning system 1 is represented as an example in the form of an air-conditioning system with two temperature zones in which a driver zone 9.1 for the area of the driver seat 7.1 is air-conditioned as a first temperature zone 9.1 and a passenger zone 9.2 for the area of the passenger seat 7.2 is air-conditioned as a second temperature zone 9.2. For temperature zone separation, the motor vehicle air-conditioning system 12 has a separating wall 13 which serves to separate the air flow 8 into a partial air flow 8.1 guided in the driver zone 9.1 and a partial air flow 8.2 guided in the passenger zone 9.2 and to separate both partial air flows 8.1, 8.2 from one another. Additionally, an air bypass 14 which can be opened and closed is formed in the area of the separating wall 13 for a connection between the driver zone 9.1 and the passenger zone 9.2. According to the representation in FIG. 2, the air bypass 14 is formed in the shape of a through opening within the separating wall 13 which can be opened and closed by a bypass flap 16 which is driven by a flap adjustment drive 15 and has a sealing. The air bypass 14 is placed downstream of the evaporator 4 and the thermal heat exchanger 5.

When the driver zone 9.1 is activated, there is an air supply from the air guided in the partial air flow 8.1 in the driver zone 9.1 into the motor vehicle interior 6 via corresponding air outlets on the driver side 11.1. When the passenger zone 9.2 is activated, there is an air supply from the air guided in the partial air flow 8.2 in the passenger zone 9.2 into the motor vehicle interior 6 via corresponding air outlets on the passenger side 11.2. In the representation of FIG. 2, the motor vehicle air-conditioning system 12 is in “normal operation” setting, which means that both the driver zone 9.1 and the passenger zone 9.2 are activated and thus there is an air supply into the motor vehicle interior 6 both via air outlets on the driver side 11.1 and on the passenger side 11.2. Thus, there is no partial deactivation of the air supply and the air bypass 14 is closed by the bypass flap 16. The “normal operation” setting is usually used in case both the driver seat 7.1 and the passenger seat 7.2 are occupied, as indicated by two circles with a respective check-mark in the upper left part of the representation.

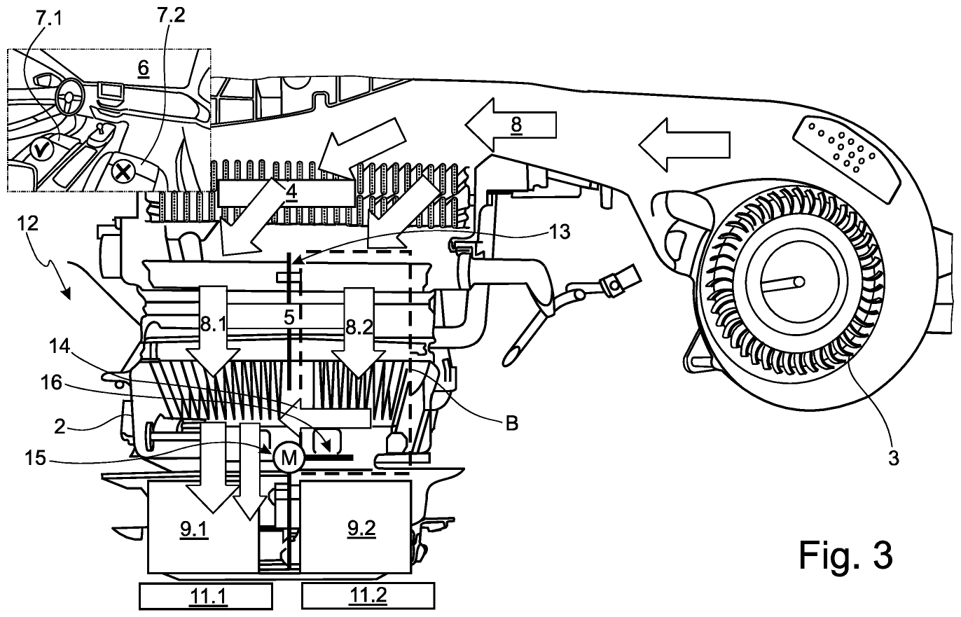

FIG. 3 shows the same motor vehicle air-conditioning system 12 as in FIG. 2 in the operating mode for the driver side, which, as already mentioned, is used when the driver seat 7.1 is occupied, but not the passenger seat 7.2. In the upper left part of FIG. 3 as well, a partial area of the motor vehicle interior 6 with the occupied driver seat 7.1, indicated by a circle with a check-mark, and the free passenger seat 7.2, indicated by a crossed-out circle, is represented in perspective. In the operating mode for the driver side, the zone deactivation function for the passenger zone 9.2 is active. This means that the air outlets on the passenger side 11.2 are closed and the air supply for the passenger seat 7.2 is thus deactivated. However, in the shown setting, the bypass flap 16 was placed into the opened position by means of the flap adjustment drive 15 and thus the air bypass 14, which forms a through opening through the separating wall 13, is opened. Here, the deactivation of the air supply on the passenger side 11.2 does not lead to the prevention of the complete partial air flow 8.2 within the passenger zone 9.2 to the right of the separating wall 13 as the partial air flow 8.2, after passing the evaporator 4 and optionally the thermal heat exchanger 5, is redirected through the air bypass 14 into the driver zone 9.1 to the left of the separating wall 13 and there it can exit into the motor vehicle interior 6 together with the corresponding partial air flow 8.1 via the air outlets on the driver side 11.1. For the motor vehicle air-conditioning system 12 shown in FIG. 2 and FIG. 3, in the operating mode for the drive side as well, 100% of the cross-section of the evaporator 4 and of the thermal heat exchanger 5 can respectively be used, which leads to a greater heat transfer performance. Opening the bypass flap 16 not only enables the further use of the complete thermal heat exchanger 5, i.e. in the flow area B which is not blocked anymore as well, but also enlarges the flow cross-section for guiding the air within the motor vehicle air-conditioning system 12. The additionally gained heat transfer performance and the non-prevented, but redirected partial air flow 8.2 can be used for supporting the air-conditioning of the driver side 11.1. Compared to the state of the art shown above, this leads to an improved efficiency, a lower energy consumption and a lower noise level during the operating mode for the driver side.

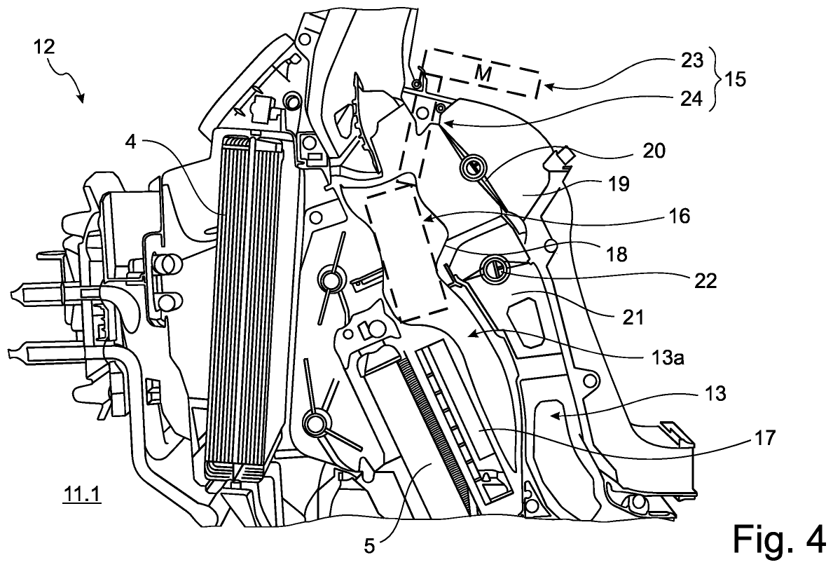

FIG. 4 shows a schematic side view of the motor vehicle air-conditioning system 12 in cross-section, wherein the sectional plane along the driving axis x runs, among others, through the evaporator 4, the thermal heat exchanger 5, an additional electric heater 17 arranged downstream of the thermal heat exchanger 5, the mixing space 18 and the air outlets for the air supply into the motor vehicle interior, i.e. through an evaporation outlet 19 with an evaporation outlet flap 20 and a foot space outlet 21 with a foot space outlet flap 22, facing the separating wall 13 between the driver zone and the passenger zone as viewed from the driver side 11.1. FIG. 4 schematically shows the required components and/or their position within the motor vehicle air-conditioning system 12. FIG. 4 outlines the possible installation area 13a of the air bypass in the separating wall 13 of the motor vehicle air-conditioning system 12 just as the possible setup and installation area of the flap adjustment drive 15 which comprises a drive engine 23 and a drive axis 24 which connects the drive engine 23 and the bypass flap 16 to one another. In doing so, the bypass flap 16 is in the mixing space 18 arranged downstream of the evaporator 4 and of the thermal heat exchanger 5 in which the cold air path coming from the evaporator 4 and avoiding the thermal heat exchanger 5 and the warm air path running through the thermal heat exchanger 5 and the additional electrical heater 17 meet.

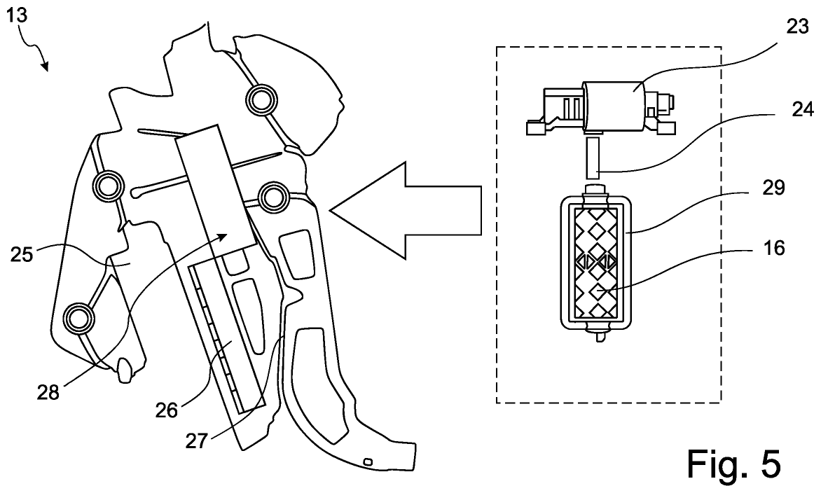

FIG. 5 shows a side view of the separating wall 13 which is usually provided with different recesses for the components to be guided through the separating wall 13, for example a recess 25 open at the bottom for the thermal heat exchanger, a rectangularly closed recess 26 for the electrical heater and a usually very narrow recess 27 open at the bottom for guiding a wall of the warm air path positioned in front of the foot space outlet through. As a further recess, there is an installation opening 20 for the bypass flap 16, wherein the latter is represented in detail in the right part of FIG. 5. FIG. 5 shows that the bypass flap 16 has a circumferential sealing 29 at the edge. Furthermore, in the right part of FIG. 5, an assembly of the bypass flap 16 with the drive engine 23 and the drive axis 24 is represented in detail, wherein this assembly enables an active bypass function.

### LIST OF REFERENCE NUMERALS

1 motor vehicle air-conditioning system, prior art
2 housing
3 fan
4 evaporator
5 thermal heat exchanger
6 motor vehicle interior
7.1 driver seat
7.2 passenger seat
8 air flow
8.1 partial air flow to driver side
8.2 partial air flow to passenger side
9.1 driver zone, first temperature zone
9.2 passenger zone, second temperature zone
10 separating wall, prior art
11.1 driver side
11.2 passenger side
12 motor vehicle air-conditioning system
13 separating wall
13a installation area of an air bypass in the separating wall
14 air bypass
15 flap adjustment drive
16 bypass flap
17 electrical heater
18 mixing space
19 ventilation outlet
20 ventilation outlet flap
21 foot space outlet
22 foot space outlet flap
23 drive engine
24 drive axis
25 recess for the thermal heat exchanger
26 recess for the electrical heater
27 recess for a wall of the warm air path
28 installation opening for the bypass flap
29 sealing of the bypass flap

What is claimed is:

1. A motor vehicle air-conditioning system, comprising:
a housing for guiding an air flow, in which air outlets for an air supply into a motor vehicle interior are formed,
an evaporator through-flowable by the air flow, and a thermal heat exchanger arranged in the housing, through-flowable by the air flow downstream of the evaporator, wherein, starting from the evaporator, a cold air path bypassing the thermal heat exchanger and a warm air path running through the thermal heat exchanger lead downstream into a mixing space, which is connected to the air outlets,
at least one separating wall which runs through the housing such that it separates the housing into at least two flow areas for the air flow along the cold air path, the warm air path, the mixing space and the air outlets, which represent two temperature zones that can be air-conditioned and are spatially separated from one another, which have air outlet areas for the air supply into respective different areas of the motor vehicle interior, wherein the air outlet areas can be closed and opened by operating flaps, and
an air bypass which can be closed and opened, for a direct fluidic connection between the two temperature zones.

2. The air-conditioning system according to claim 1, wherein the air bypass is in a shape of a through opening within the at least one separating wall that can be closed and opened.

3. The motor vehicle air-conditioning system according to claim 1, wherein the air bypass is in the mixing space.

4. The motor vehicle air-conditioning system according to claim 1, wherein a bypass flap with which the air bypass can be closed and opened is arranged on the air bypass.

5. The motor vehicle air-conditioning system according to claim 4, wherein the motor vehicle air-conditioning system has a flap adjustment mechanism with which the bypass flap can be adjusted between a closing position and at least one opening position.

6. The motor vehicle air-conditioning system according to claim 4, wherein the bypass flap has a sealing running around its edge.

7. The motor vehicle air-conditioning system according to claim 6, wherein there is an operative connection between an activation function and a deactivation function of the air supply from the two temperature zones into the motor vehicle interior and an activation function and a deactivation function of the air bypass in that the air bypass is closed or opened in dependence on an activation or a deactivation of the air supply from the two temperature zones.

8. The motor vehicle air-conditioning system according to claim 7, wherein the operative connection is between at least one operating flap of the two temperature zone by means of which the two temperature zones can be activated by opening the air outlet areas for the air supply into the motor vehicle interior or deactivated by closing the same, and the bypass flap of the air bypass by means of which the air bypass can be opened or closed.

9. The motor vehicle air-conditioning system according to claim 1, wherein of the two temperature zones, a first one of the temperature zones is located on a driver side as a driver zone and is connected to the air outlets which can be closed and opened for the air supply for a driver seat, and a second one of the temperature zones, separated from the first one of the temperature zones by the at least one separating wall, is located on a passenger side as a passenger zone and is connected to the air outlet areas which can be closed and opened for the air supply for a passenger seat.

10. A method for operating the motor vehicle air-conditioning system according to claim 1, wherein the air bypass is closed or opened in dependence on an activation or a deactivation of the air supply from at least one of the temperature zones.

11. The method according to claim 10, wherein, when the air supply from a first one of the temperature zones into the motor vehicle interior is deactivated, a partial air flow flowing in the first one of the temperature zones, which is redirected into a second one of the temperature zones by the opened air bypass, the air supply of which into the motor vehicle interior is activated, and, together with the partial air flow of the second one of the temperature zones exits into the motor vehicle interior via the air outlet areas.
